(19) United States
(12) Patent Application Publication
(10) Pub. No.: US 2025/0116290 A1
(43) Pub. Date: Apr. 10, 2025

(54) RETAINING ASSEMBLY

(71) Applicant: FIVEGRAND INTERNATIONAL CO., LTD., New Taipei City (TW)

(72) Inventor: TING-JUI WANG, New Taipei City (TW)

(73) Assignee: FIVEGRAND INTERNATIONAL CO., LTD., New Taipei City (TW)

(21) Appl. No.: 18/824,953

(22) Filed: Sep. 5, 2024

(30) Foreign Application Priority Data
Oct. 6, 2023 (TW) 112138582

(51) Int. Cl. F16B 39/10

(52) U.S. Cl. CPC F16B 39/10

(57) ABSTRACT

A retaining assembly includes a fixing seat, having an assembly portion and a first anti-rotation portion, the assembly portion for fixing at a first object; a fixing member, inserted at the fixing seat and having a stop unit, a connection unit and fixing unit that are sequentially connected; a fixing member reciprocation generating member, having a second anti-rotation portion aligned with the first anti-rotation portion, for restricting and preventing rotation of the fixing member reciprocation generating member, the fixing member reciprocation generating member displacing relative to the fixing seat to drive the fixing member to reciprocate; and an elastic element, located in the fixing seat, two ends of the elastic member respectively abutting against the fixing seat and the fixing unit.

### CROSS-REFERENCE TO RELATED APPLICATION

This non-provisional application claims priority under 35 U.S.C. § 119(a) on Patent Application No(s). 112138582 filed in Taiwan, R.O.C. on Oct. 6, 2023, the entire contents of which are hereby incorporated by reference.

### BACKGROUND OF THE INVENTION

### 1. Field of the Invention

The present disclosure relates to a retaining assembly, and in particular to a retaining assembly which uses a fixing member reciprocation generating member to prevent a fixing member from swaying easily and readily enable a fixing unit to reciprocate inside and outside a fixing seat or reciprocate outside the fixing seat.

### 2. Description of the Related Art

A tool conventionally used for fixing two objects is mostly a socket screw,

which primarily includes a socket, a screw and a spring. During use of such conventional socket screw, the socket is first fixed at an object, and then the screw is inserted through the object and locked at another object, thereby fixing the two objects.

### BRIEF SUMMARY OF THE INVENTION

However, the screw of the conventional socket screw can sway easily relative to the socket and suffers from difficulties in aligning with a fixing hole of the other object. Moreover, a screw head of the conventional socket screw is small and cannot be conveniently pressed downward or pulled upward. Therefore, it is an object of the present disclosure to disclose a retaining assembly which uses a fixing member reciprocation generating member to prevent a fixing member from swaying easily and readily enable a fixing unit to reciprocate inside and outside a fixing seat or reciprocate outside the fixing seat.

In view of the drawbacks above, the applicant is dedicated to extensive research and development based on experiences over the years in related art, in the aim of providing a retaining assembly, which uses a fixing member reciprocation generating member to achieve objects of preventing a fixing member from swaying easily and readily enabling a fixing unit to reciprocate inside and outside a fixing seat or reciprocate outside the fixing seat.

To achieve the above and other objects, a retaining assembly provided according to a first implementation form of the present disclosure includes: a fixing seat, for fixing at a first object; a fixing member, having a stop unit, a connection unit and fixing unit that are sequentially connected, the fixing unit for fixing at a second object; a fixing member reciprocation generating member, movably disposed at the fixing seat, the connection unit movably disposed at the fixing member reciprocation generating member and the fixing seat, the stop unit stopping at the fixing member reciprocation generating member, the fixing unit reciprocating inside and outside the fixing seat, or the fixing unit reciprocating outside the fixing seat; and an elastic element, having one end abutting against the fixing seat and the other end abutting against the fixing member.

In another specific embodiment according to the first implementation form of the retaining assembly, the retaining assembly includes: a fixing seat, for fixing at a first object; a fixing member, having a stop unit, a connection unit and fixing unit that are sequentially connected, the fixing unit for fixing at a second object; a fixing member reciprocation generating member, movably disposed at the fixing seat, the fixing member reciprocation generating member having a retraction and obtrusion unit, the connection unit movably disposed at the fixing member reciprocation generating member and the fixing seat, the stop unit stopping at the retraction and obtrusion unit, the fixing unit reciprocating inside and outside the fixing seat, or the fixing unit reciprocating outside the fixing seat; and an elastic element, having one end abutting against the fixing seat and the other end abutting against the fixing member.

In another specific embodiment according to the first implementation form of the retaining assembly, the retaining assembly includes: a fixing seat, for fixing at a first object; a fixing member, having a stop unit, a connection unit and fixing unit that are sequentially connected, the fixing unit for fixing at a second object; a fixing member reciprocation generating member, movably disposed at the fixing seat, the fixing member reciprocation generating member having an outward tilted stop surface, the stop unit having an inward tilted stop surface, the outward tilted stop surface and the inward tilted stop surface slidably moving relative to each other, the connection unit movably disposed at the fixing member reciprocation generating member and the fixing seat, the fixing unit reciprocating inside and outside the fixing seat, or the fixing unit reciprocating outside the fixing seat; and an elastic element, having one end abutting against the fixing seat and the other end abutting against the fixing member.

In the retaining assembly above, the fixing member reciprocation generating member has a positioning slot, and the stop unit is temporarily positioned at the positioning slot.

In the retaining assembly above, the fixing member reciprocation generating member has a groove, and a retraction region, an outward tilted stop surface and an obtrusion region sequentially connected to form a step, the groove is in communication with the retraction region, the outward tilted stop surface and the obtrusion region, the connection unit is movably disposed at the groove and the fixing seat, and the stop unit stops in the retraction region, the outward tilted stop surface or the obtrusion region.

In the retaining assembly above, the fixing member reciprocation generating member has a groove, and a retraction region, an outward tilted stop surface and an obtrusion region sequentially connected to form a step, the groove is in communication with the retraction region, the outward tilted stop surface and the obtrusion region, the connection unit is movably disposed at the groove and the fixing seat, the stop unit stops in the retraction region, the outward tilted stop surface or the obtrusion region, and the positioning slot is located in the obtrusion region.

In the retaining assembly above, the fixing seat has a riveted unit, an engaging connection unit, an expansion connection unit, a welded unit, a locked unit, a magnetic attraction unit, an adhesion unit or a lateral assembly unit so as to be fixed at the first object.

In the retaining assembly above, the fixing seat is formed integrally with the first object.

In the retaining assembly above, the fixing unit is a column, a fastener, an elastic fastener or a screw thread so as to be fixed at the second object.

In the retaining assembly above, a material forming the fixing member reciprocation generating member is plastic, acrylic, silicone or rubber.

In the retaining assembly above, a material forming the fixing member reciprocation generating member is carbon steel, zinc alloy, aluminum alloy, copper or stainless steel.

Thus, the retaining assembly of the present disclosure can use the fixing member reciprocation generating member to prevent the fixing member from swaying easily, and readily enable the fixing unit to reciprocate inside and outside the fixing seat or reciprocate outside the fixing seat.

A retaining assembly according to a second implementation form of the present disclosure includes: a fixing seat, having a first anti-rotation portion; a fixing member, inserted at the fixing seat and having a stop unit, a connection unit and a fixing unit that are sequentially connected; and a fixing member reciprocation generating member, having a second anti-rotation portion aligned with the first anti-rotation portion, for restricting and preventing rotation of the fixing member reciprocation generating member, the fixing member reciprocation generating member displacing relative to the fixing seat to drive the fixing member to reciprocate.

In the retaining assembly above, the first anti-rotation portion or the second anti-rotation portion can be a plane, or the first anti-rotation portion or the second anti-rotation portion can be a recess or a protrusion.

In the retaining assembly above, the second anti-rotation portion has an extended structure or a hook connected to the structure, or a head of the fixing seat is accommodated between the hook and the base plate, or the hook is aligned with the first anti-rotation portion and extends into a shoulder of the fixing seat.

In the retaining assembly above, the first anti-rotation portion and an assembly portion of the fixing seat can have an auxiliary limiting portion in between, or the second anti-rotation portion can extend to be between the first anti-rotation portion and the auxiliary limiting portion.

In the retaining assembly above, the first anti-rotation portion can form a plane on each of two radially opposite positions, so that the first anti-rotation portion can be formed to be symmetrical.

In the retaining assembly above, the second anti-rotation portion can have two plates extending downward from the base plate, or each of the plates can be connected to a hook and the two hooks can face each other, or a head of the fixing seat can be accommodated between the two hooks and the base plate, or the two hooks can be aligned with the two planes and can extend into a shoulder of the fixing seat.

In the retaining assembly above, the assembly portion of the fixing seat and a fixing through hole of a first object can form a matching anti-rotation structure, or are for limiting a direction of the fixing seat at the first object or restricting or conforming to limiting directions of the first anti-rotation portion and the second anti-rotation portion.

In the retaining assembly above, the limiting directions of the first anti- rotation portion and the second anti-rotation portion can be used for restricting a motion direction of the fixing member reciprocation generating member.

A retaining assembly further provided according to the second implementation form of the present disclosure includes: a fixing seat, having a third anti-rotation portion; a fixing member, inserted at the fixing seat and having a stop unit, a connection unit and a fixing unit that are sequentially connected, the fixing member having a fourth anti-rotation portion corresponding to the third anti-rotation portion, and for restricting and preventing rotation of the fixing member; and a fixing member reciprocation generating member, displacing relative to the fixing seat so as to drive the fixing member to reciprocate.

In the retaining assembly above, a radial cross section of an accommodating chamber in the fixing seat can be formed to have a non-circular pattern so as to form the third anti-rotation portion, or a radial cross section of the fixing unit at the fourth anti-rotation portion can be formed to have a pattern matching the accommodating chamber.

A retaining assembly further provided according to the second implementation form of the present disclosure includes: a fixing seat; a fixing member, inserted at the fixing seat and having a stop unit, a connection unit and a fixing unit that are sequentially connected, the fixing member having a fourth anti-rotation portion; and a fixing member reciprocation generating member, having a fifth anti-rotation portion corresponding to the fourth anti-rotation portion, for restricting and preventing rotation of the fixing member, the fixing member reciprocation generating member displacing relative to the fixing seat to drive the fixing member to reciprocate.

In the retaining assembly above, an outward tilted stop surface of a retraction region of the fixing member reciprocation generating member can be formed as an inverted cone having a non-circular pattern so as to form the fifth anti-rotation portion, or the stop unit of the fixing member can be formed to have a pattern matching the outward tilted stop surface so as to form the fourth anti-rotation portion.

A retaining assembly further provided according to the second implementation form of the present disclosure includes: a fixing seat; a fixing member, inserted at the fixing seat and having a stop unit, a connection unit and a fixing unit that are sequentially connected; a fixing member reciprocation generating member, displacing relative to the fixing seat to drive the fixing member to reciprocate; and an elastic reset member, having one end abutting against the fixing member reciprocation generating member and the other end abutting against the fixing member, for locating the fixing member at a descending position or an ascending position.

In the retaining assembly above, the fixing member reciprocation generating member can have an extension portion, one end of the elastic reset member can abut against the extension portion, or the extension portion can be provided with a recess for accommodating the one end of the elastic reset member.

In the retaining assembly above, the fixing member reciprocation generating member can have a retraction region and an obtrusion region, or the stop unit can protrude when aligned with the obtrusion region, or the stop unit can be at least partially immersed when aligned with the retraction region, or the fixing member reciprocation generating member can have an extension portion, and the extension portion is closer to the obtrusion region and farther away from the retraction region, or the one end of the elastic reset member can abut against the extension portion.

In the retaining assembly above, the fixing member reciprocation generating member can have a retraction region and an obtrusion region, or the stop unit can protrude when aligned with the obtrusion region, or the stop unit can be at least partially immersed when aligned with the retraction region, or the fixing member reciprocation generating member can have an extension portion, and the extension portion is closer to the retraction region and farther away from the obtrusion region, or the one end of the elastic reset member can abut against the extension portion.

A retaining assembly further provided according to the second implementation form of the present disclosure includes: a fixing seat; a fixing member, inserted at the fixing seat and having a stop unit, a connection unit and a fixing unit that are sequentially connected, the fixing unit having a guide surface for guiding the fixing unit to move or operate; and a fixing member reciprocation generating member, displacing relative to the fixing seat so as to drive the fixing member to reciprocate.

In the retaining assembly above, the guide surface can be an arched surface, a round surface, a curved surface, a stepped surface of a sloped surface.

In the retaining assembly above, the fixing unit can have a limiting portion for restricting a second object, or one side of the fixing unit can have the guide surface and one other side can have a limiting portion for guiding the fixing unit by the guide surface to enter the second object or being restricted by the limiting portion from separating.

In the retaining assembly above, the fixing member and the fixing seat are restricted and prevented from rotation, or the fixing member and the fixing member reciprocation generating member are restricted and prevented from rotation, so as to restrict a direction of the guide surface or a direction of a limiting portion of the fixing unit.

In the retaining assembly above, the fixing member reciprocation generating member can have a retraction and obtrusion unit, or the connection unit can be inserted at the retraction and obtrusion unit and a through hole of the fixing seat, or when the fixing member reciprocation generating member displaces relative to the fixing seat, the retraction and obtrusion unit can drive the fixing member to reciprocate so as to compress or release an elastic element.

In the retaining assembly above, the fixing member reciprocation generating member can have a retraction and obtrusion unit, and the retraction and obtrusion unit can have a groove, or the groove can have a retraction region and at least one obtrusion region connected to each other, or the stop unit can protrude out of the groove when aligned with the obtrusion region, or the stop unit can be at least partially immersed in the groove when aligned with the retraction region, or the obtrusion region of the groove can be two in quantity, or the retraction region can be located between the two obtrusion regions, or the stop unit can be formed as an inverted cone tapered gradually toward the connection unit and can have an inward tilted stop surface, or the groove can be provided with an outward tilted stop surface in the retraction region so as to correspond to the inward tilted stop surface.

In the retaining assembly above, the fixing member reciprocation generating member can be provided with at least one lift portion.

In the retaining assembly above, the fixing seat can have an assembly portion which is for fixing at a first object.

The retaining assembly above can further include an elastic element which can be located at the fixing seat, and two ends of the elastic element can respectively abut against the fixing seat and the fixing unit.

In the retaining assembly above, the fixing unit is for fixing, limiting or restricting at a second object, or the fixing unit is for fixing, limiting or restricting the fixing seat, the fixing member or the fixing member reciprocation generating member.

In the retaining assembly above, the fixing seat can be for fixing at a first object, or the fixing unit can be for restricting a second object, or the first object or the second object can be a server, a memory, a motherboard, a printed circuit board (PCB), a rail, a cabinet, a data center, an integrated circuit (IC), a chip, a heat sink, a fan, a casing, a housing, a metal object or a plastic object.

Accordingly, with the first anti-rotation portion and the second anti-rotation portion matching each other provided, the retaining assembly of the second implementation form of the present disclosure can further limit the fixing member reciprocation generating member to only displace relative to the fixing seat without any relative rotation, thereby achieving effects of stability, convenience and efficiency of operation during an assembly process.

### BRIEF DESCRIPTION OF THE DRAWINGS

FIG. 1 is an exploded schematic diagram of a specific embodiment according to a first implementation form of the present disclosure.

FIG. 2 is a first schematic diagram of operation of a specific embodiment according to the first implementation form of the present disclosure.

FIG. 3 is a second schematic diagram of operation of a specific embodiment according to the first implementation form of the present disclosure.

FIG. 4 is a third schematic diagram of operation of a specific embodiment according to the first implementation form of the present disclosure.

FIG. 5 is a side cross-sectional schematic diagram of a specific embodiment according to the first implementation form of the present disclosure, wherein a fixing member reciprocation generating member has a positioning slot.

FIG. 6 is a side cross-sectional schematic diagram of a specific embodiment according to the first implementation form of the present disclosure, wherein a fixing seat has a riveted unit.

FIG. 7 is a side cross-sectional schematic diagram of a specific embodiment according to the first implementation form of the present disclosure, wherein a fixing seat has an expansion connection unit.

FIG. 8 is a side cross-sectional schematic diagram of a specific embodiment according to the first implementation form of the present disclosure, wherein a fixing seat has a welded unit.

FIG. 9 is a side cross-sectional schematic diagram of a specific embodiment according to the first implementation form of the present disclosure, wherein a fixing seat has a locked unit.

FIG. 10 is a side cross-sectional schematic diagram of a specific embodiment according to the first implementation form of the present disclosure, wherein a fixing seat has a lateral assembly unit.

FIG. 11 is a side cross-sectional schematic diagram of a specific embodiment according to the first implementation form of the present disclosure, wherein a fixing seat is formed integrally with an object.

FIG. 12 is a side cross-sectional schematic diagram of a specific embodiment according to the first implementation form of the present disclosure, wherein a fixing unit is a fastener.

FIG. 13 is a side cross-sectional schematic diagram of a specific embodiment according to the first implementation form of the present disclosure, wherein a fixing unit is an elastic fastener.

FIG. 14 is a side cross-sectional schematic diagram of a specific embodiment according to the first implementation form of the present disclosure, wherein a fixing unit is a screw thread.

FIG. 15 is an exploded schematic diagram of a specific embodiment according to a second implementation form of the present disclosure.

FIG. 16 is a cross-sectional schematic diagram of a combination of a fixing member reciprocation generating member and a fixing seat in a lateral direction of a specific embodiment according to the second implementation form of the present disclosure.

FIG. 17 is a cross-sectional schematic diagram of a combination of a fixing member reciprocation generating member and a fixing seat in a longitudinal direction of a specific embodiment according to the second implementation form of the present disclosure.

FIG. 18 is a schematic diagram of operation of a specific embodiment according to the second implementation form of the present disclosure.

FIG. 19 is an exploded schematic diagram of another specific embodiment according to the second implementation form of the present disclosure.

FIG. 20 is a cross-sectional schematic diagram of a combination of yet another specific embodiment according to the second implementation form of the present disclosure.

FIG. 21 is a top schematic diagram of a fixing member reciprocation generating member of another specific embodiment according to the second implementation form of the present disclosure.

FIG. 22 is a bottom cross-sectional schematic diagram of a fixing seat coupled with a fixing member of yet another specific embodiment according to the second implementation form of the present disclosure.

FIG. 23 is a first side schematic diagram of a combination of another specific embodiment according to the second implementation form of the present disclosure.

FIG. 24 is a second side schematic diagram of a combination of another specific embodiment according to the second implementation form of the present disclosure.

FIG. 25 is a third side schematic diagram of a combination of yet another specific embodiment according to the second implementation form of the present disclosure.

FIG. 26 is a top schematic diagram of one of the specific embodiments according to the second implementation form of the present disclosure.

FIG. 27 is a cross-sectional schematic diagram of a combination of one of the specific embodiments according to the second implementation form of the present disclosure, wherein an elastic reset member disposed laterally is provided.

FIG. 28 is a cross-sectional schematic diagram of a combination of one of the specific embodiments according to the second implementation form of the present disclosure, wherein an elastic reset member in another configuration form is provided.

### DETAILED DESCRIPTION OF THE INVENTION

To facilitate understanding of the object, characteristics and effects of this present disclosure, embodiments together with the attached drawings for the detailed description of the present disclosure are provided.

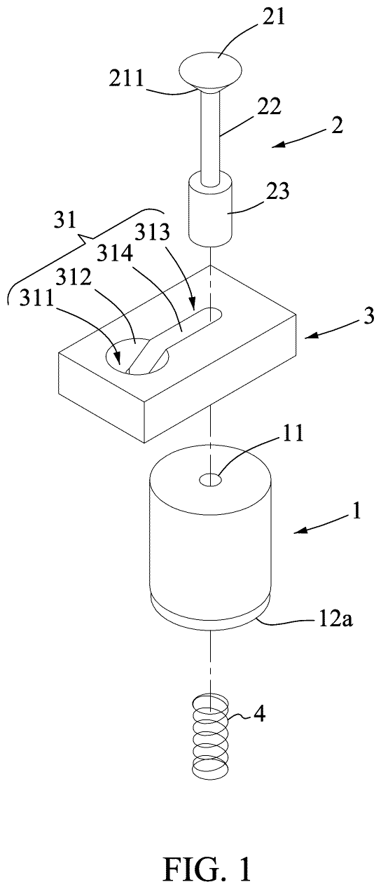

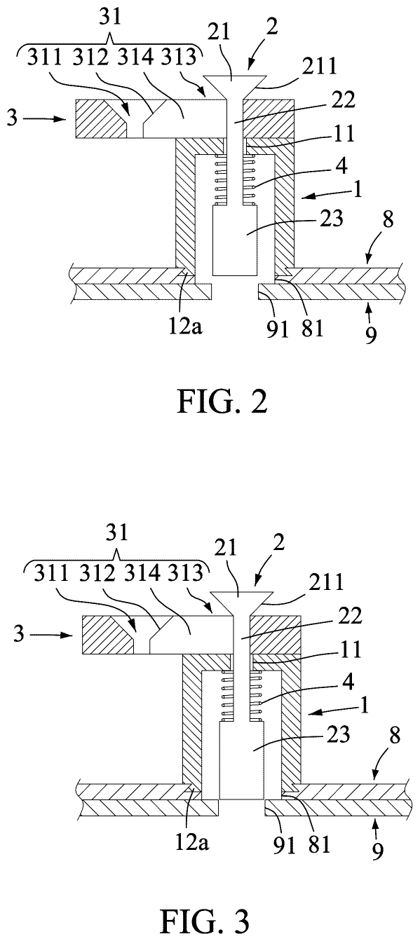

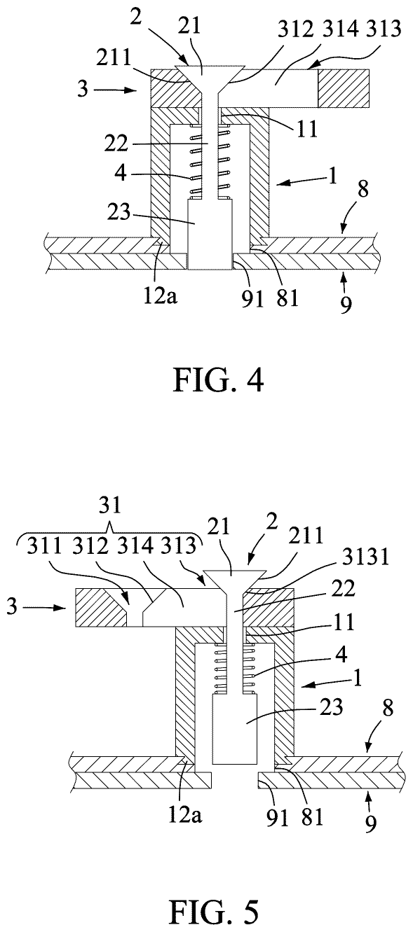

As shown in FIG. 1 to FIG. 4, in one of the specific embodiments according to a first implementation form of the present disclosure, a retaining assembly includes a fixing seat 1, a fixing member 2, a fixing member reciprocation generating member 3 and an elastic element 4. The fixing seat 1 can be fixed at a fixing through hole 81 of a first object 8 (for example, a plate or an object in other structures) by an engaging connection unit 12a at a bottom of the fixing seat 1, and the fixing seat 1 can have a cap shape and has a through hole 11 on a top thereof. The fixing member 2 has a stop unit 21, a connection unit 22 and a fixing unit 23 that are sequentially connected. The fixing member 2 is gradually tapered from the stop unit 21 toward the connection unit 22. The fixing unit 23 is for penetrating the fixing through hole 81 of the first object 8 and is fixed at a fixing hole 91 (for example, a through hole or an indented hole) of a second object 9 (for example, a plate or an object of other structures). The fixing unit 23 can be a column and has a cross section area slightly greater than that of the fixing hole 91 to allow the fixing unit 23 to enter the fixing hole 91, further enabling the fixing unit 23 to be fixed at the fixing hole 91. The fixing member reciprocation generating member 3 is movably disposed on the fixing seat 1 and can laterally displace relative to the fixing seat 1. The connection unit 22 penetrates the fixing member reciprocation generating member 3 and the through hole 11 of the fixing seat 1, and is movably disposed at the fixing member reciprocation generating member 3 and the fixing seat 1. The stop unit 21 stops at the fixing member reciprocation generating member 3. The elastic unit 4 can be a telescopic spring or a spring or elastic body in other forms and can sleeve the connection unit 22. One end of the elastic element 4 abuts against a top within the fixing seat 1, and the other end abuts on the fixing unit 23 of the fixing member 2. To assemble the fixing member 2, the fixing seat 1 and the fixing member reciprocation generating member 3, the fixing seat 1 and the fixing member reciprocation generating member 3 are first penetrated by the connection unit 22, and then the stop unit 21 or the fixing unit 23 is assembled at the connection unit 22, or the connection unit 22 is processed to form the stop unit 21 or the fixing unit 23. When the fixing member reciprocation generating member 3 moves toward the left (as shown in FIG. 2 or FIG. 3), the fixing member reciprocation generating member 3 pushes the stop unit 21 (the fixing member 2) to move upward and causes the fixing seat 1 and the fixing unit 23 to pressurize the elastic element 4. With an outward pre-force generated by the elastic member 4 that is pressurized, the fixing member 2 can steadily abut against the fixing member reciprocation generating member 3 without swaying easily, further for the fixing unit 23 to be easily aligned with the fixing hole 91 of the second object 9. When the fixing member reciprocation generating member 3 moves toward the right (as shown in FIG. 4), the elastic element 4 releases the pre-force for the stop unit 21 to retract into the fixing member reciprocation generating member 3 and to move the fixing member 2 downward, further for the fixing unit 23 to enter the fixing hole 91 of the second object 9, thereby achieving an effect of fixing the first object 8 and the second object 9.

In conclusion, in the retaining assembly according to the first implementation form of the present disclosure, with the fixing member reciprocation generating member 3 and the elastic member 4, the fixing unit 23 is caused to reciprocate and the fixing member 2 is kept from swaying easily. Moreover, in the retaining assembly according to the first implementation form of the present disclosure, with the fixing member reciprocation generating member 3, the fixing unit 23 can easily reciprocate outside and inside the fixing seat 1 (as shown in FIG. 2 and FIG. 4), or reciprocate outside the fixing seat 1 (as shown in FIG. 3 and FIG. 4).

Referring to FIG. 1 to FIG. 4, in the retaining of another specific embodiment according to the first implementation form of the present disclosure, the fixing member reciprocation generating member 3 has a retraction and obtrusion unit 31. The retraction and obtrusion unit 31 can cause the stop unit 21 of the fixing member 2 to retract into the retraction and obtrusion unit 31, or obtrude the stop unit 21 of the fixing member 2, further for the fixing unit 23 to reciprocate outside and inside the fixing seat 1 (as shown in FIG. 2 and FIG. 4), or reciprocate outside the fixing seat 1 (as shown in FIG. 3 and FIG. 4).

Referring to FIG. 1 to FIG. 4, in the retaining of yet another specific embodiment according to the first implementation form of the present disclosure, the fixing member reciprocation generating member 3 has an outward tilted stop surface 312 and the stop unit 21 has an inward tilted stop surface 211. The outward tilted stop surface 312 and the inward tilted stop surface 211 can slidably move relative to other, further for the fixing unit 23 to reciprocate outside and inside the fixing seat 1 (as shown in FIG. 2 and FIG. 4), or reciprocate outside the fixing seat 1 (as shown in FIG. 3 and FIG. 4).

As shown in FIG. 5, the fixing member reciprocation generating member 3 of the retaining assembly above can have a positioning slot 3131, the stop unit 21 can be temporarily positioned at the positioning slot 3131, the fixing unit 23 can be temporarily located inside or outside the fixing seat 1 (as shown in FIG. 5 and FIG. 3), and the positioning slot 3131 can prevent the fixing member reciprocation generating member 3 from moving arbitrarily by an inappropriate external force.

Again referring to FIG. 1 to FIG. 4, (the retraction and obtrusion unit 31 of) the fixing member reciprocation generating member 3 of the retaining assembly above has a groove 314, and a retraction region 311, an outward tilted stop surface 312 and an obtrusion region 313 that are sequentially connected. The groove 314 is in communication with the retraction region 311, the outward tilted stop surface 312 and the obtrusion region 313, the retraction region 311 is recessed relative to the obtrusion region 313, and the obtrusion region 313 is protruding relative to the retraction region 311. When the fixing member reciprocation generating member 3 moves laterally relative to the fixing seat 1, the connection unit 22 is movably disposed at the groove 314 and the fixing seat 1, and the stop unit 21 can stop in the retraction region 311, the outward tilted stop surface 312 or the obtrusion region 313, further for the fixing unit 23 to reciprocate outside and inside the fixing seat 1 (as shown in FIG. 2 and FIG. 4) or reciprocate outside the fixing seat 1 (as shown in FIG. 3 and FIG. 4). The positioning slot 3131 is located on the obtrusion region 313.

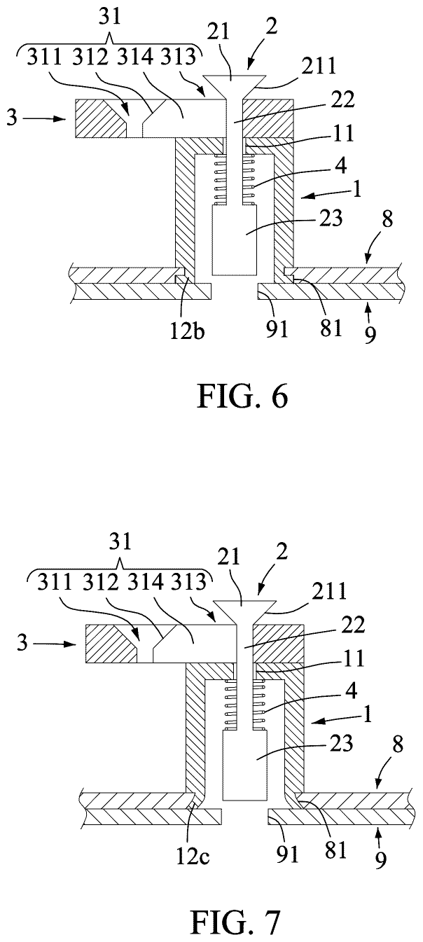

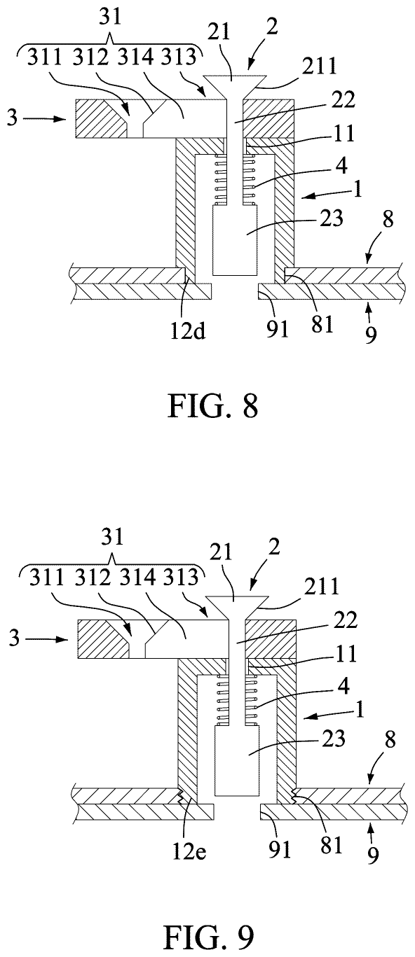

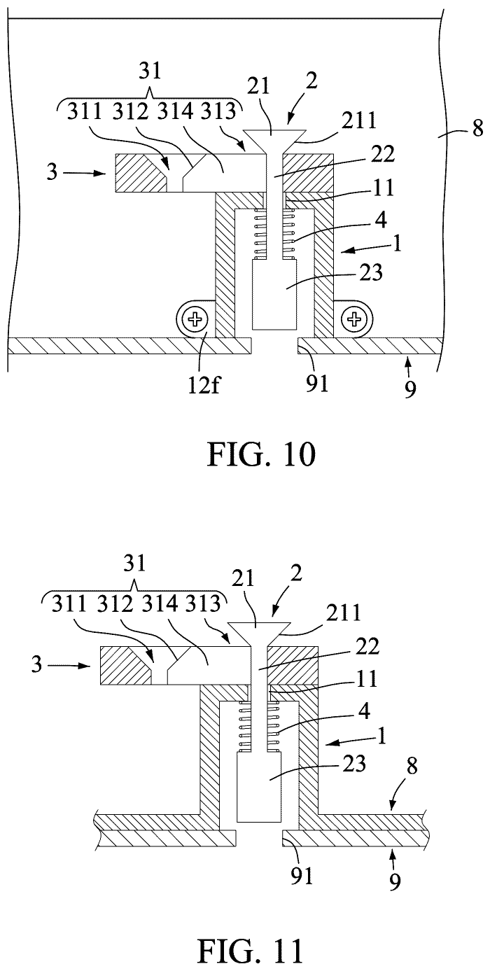

As shown in FIG. 6 to FIG. 10, in addition to the engaging connection unit 12a above, the fixing seat 1 of the retaining assembly above can be fixed to the first object 8 by a riveted unit 12b (as shown in FIG. 6), an expansion connection unit 12c (as shown in FIG. 7), a welded unit 12d (as shown in FIG. 8, which is also applicable to an adhesion unit or a magnetic attraction unit, both of which are similarly magnetic objects), a locked unit 12e (as shown in FIG. 9) or a lateral assembly unit 12f (as shown in FIG. 10) provided at a bottom thereof. The lateral assembly unit 12f causes the first object 8 and the second object 9 to be perpendicular to each other, and the lateral assembly unit 12f can be further fixed at the first object 8 by riveting, expansion connection, welding, locking, adhesion, magnetic attraction or other assembly means.

Moreover, as shown in FIG. 11, the fixing seat 1 of the retaining assembly above can be formed integrally with the first object 8.

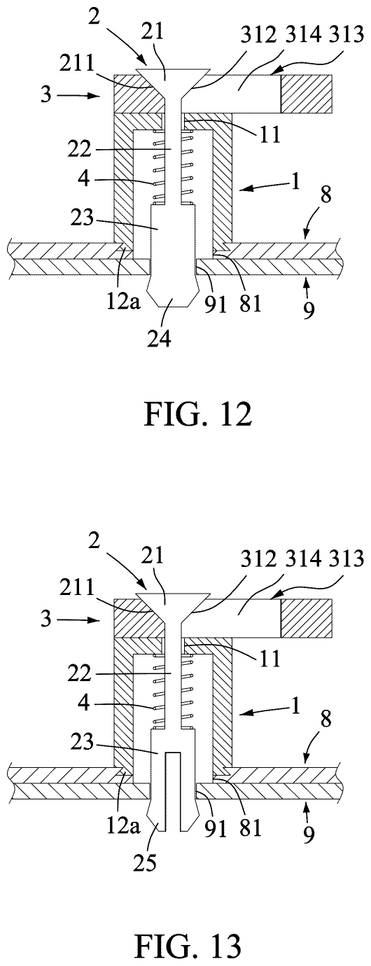

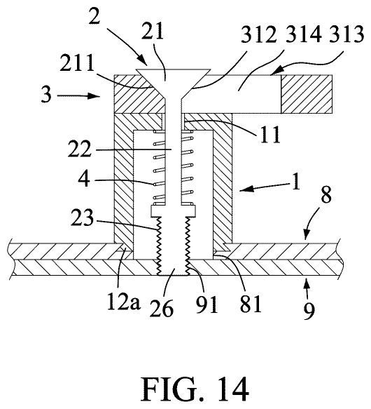

As shown in FIG. 12 to FIG. 14, in addition to the column 23 above, the fixing unit of the retaining assembly above can also be a fastener 24 (as shown in FIG. 12), an elastic fastener 25 (as shown in FIG. 13) or a screw thread 26 (as shown in FIG. 14) so as to be fixed at the second object 9.

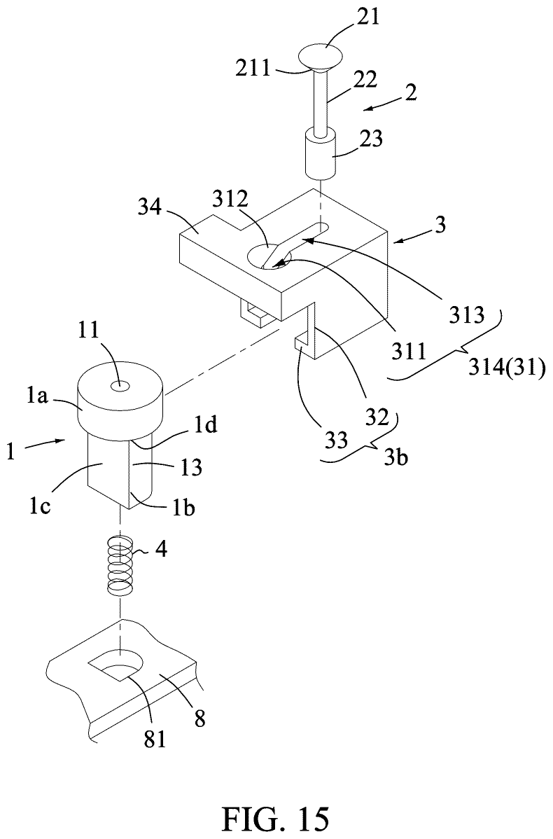

As shown in FIG. 15 to FIG. 18, in one of the specific embodiments according to a second implementation form of the present disclosure, the retaining assembly includes a fixing seat 1, a fixing member 2, a fixing member reciprocation generating member 3, and an elastic element 4. The fixing seat 1 and the fixing member reciprocation generating member 3 are respectively provided with structures for preventing relative rotation.

More specifically, the fixing seat 1 has a head la and an assembly portion 1b, wherein the head 1a can be located on a top of the fixing seat 1, and the assembly portion 1b can be located at a bottom of the fixing seat 1. An interior of the fixing seat 1 is hollow, the head 1a has a through hole 11 in communication with the interior of the fixing seat 1, and the assembly portion 1b has an accommodating chamber 1e formed therein. The assembly portion 1b can be used for fixing at a first object 8 (for example, a plate or an object of other structures), for example, for fixing at a fixing through hole 81 of the first object 8. The fixing seat 1 further has a first anti-rotation portion 13. The first anti-rotation portion 13 is located between the head la and the assembly portion 1b, and is for restricting a displacement direction of the fixing member reciprocation generating member 3 relative to the fixing seat 1 and preventing relative rotation of the two. For example but not limited to, in this specific embodiment, the first anti-rotation portion 13 can be formed at, for example but not limited to, an outer peripheral surface 1c of the fixing seat 1, and the first anti-rotation portion 13 can also form a plane on a part of the outer peripheral surface 1c of the fixing seat 1; that is, a radial cross section of the outer peripheral surface 1c of the fixing seat 1 at the first anti-rotation portion 13 is formed to have a non-circular pattern. Moreover, a shoulder 1d can be formed at a junction between the first anti-rotation portion 13 and the head 1a. Preferably, a plane is formed on each of two radially opposite positions of the first anti-rotation portion 13; for example, a plane is selectively formed on each of two radially opposite positions at the outer peripheral surface 1c of the fixing seat 1, so that the first anti-rotation portion 13 can be formed to be symmetrical.

The fixing member 2 has a stop unit 21, a connection unit 22 and a fixing unit 23 that are sequentially connected. The fixing member 2 penetrates the fixing seat 1, the stop unit 21 is located above the head 1a of the fixing seat 1, and the fixing unit 23 can be located at the accommodating chamber 1e of the assembly portion 1b and be used for fixing at a second object 9 or other objects, wherein the second object 9 can be, for example, a plate or an object of other structures, and for example, fixing at a fixing hole 91 (for example, a through hole or an indented hole) of the second object 9.

More specifically, in this specific embodiment, the fixing member 2 can penetrate the through hole 11 of the head la of the fixing seat 1 by the connection unit 22, the stop unit 21 is located on a top of the connection unit 22 and is located outside the fixing seat 1, and the stop unit 21 can be formed as an inverted cone gradually tapered toward the connection unit 22 and has an inward tilted stop surface 211. The fixing unit 23 is located at a bottom of the connection unit 22, and the form of the fixing unit 23 can differ according to assembly requirements, for example, the column as shown in FIG. 2, or can have a structure as the fastener 24 shown in 12, the elastic fastener 25 shown in FIG. 13 or the screw thread 26 shown in FIG. 14. Moreover, the elastic element 4 is located within the fixing seat 1 and sleeves the connection unit 22, two ends of the elastic element 4 respectively abut against the head la of the fixing seat 1 and the fixing unit 23, and can be, for example, a compression spring or an elastic body.

The fixing member reciprocation generating member 3 has a base plate 3a and a second anti-rotation portion 3b. The second anti-rotation portion 3b is connected to the base plate 3a, the base plate 3a is located above the head 1a of the fixing seat 1, and the second anti-rotation portion 3b is aligned with the first anti-rotation portion 13. Thus, the fixing member reciprocation generating member 3 can displace laterally relative to the fixing seat 1, and mutually limits the first anti-rotation portion 13 by the second anti-rotation portion 3b, such that the fixing member reciprocation generating member 3 can only displace relative to the fixing seat 1 without any relative rotation.

The limiting directions of the first anti-rotation portion 13 and the second anti-rotation portion 3b can be used for restricting a motion direction of the fixing member reciprocation generating member 3. The first anti-rotation portion 13 or the second anti-rotation portion 3b can be formed as a plane, or the first anti-rotation portion 13 or the second anti-rotation portion 3b can be formed as a recess or a protrusion. The second anti-rotation portion 3b can have an extended structure or a hook 33 connected to the structure, or the head 1a of the fixing seat 1 can be accommodated between the hook 33 and the base plate 3a, or the hook 33 is aligned with the first anti-rotation portion 13 and extends into the shoulder 1d of the fixing seat 1. In this specific embodiment, the second anti-rotation portion 3b can have a structure (for example, a plate 32) extending downward from the base plate 3a, and a hook 33 extending inward from the plate 32. Accordingly, the head 1a of the fixing seat 1 can be accommodated between the hook 33 and the base plate 3a, and the hook 33 can be aligned with the first anti-rotation portion 13 and extend to be below the shoulder 1d, for the fixing member reciprocation generating member 3 to displace along the first anti-rotation portion 13, with however the fixing member reciprocation generating member 3 being incapable of rotating relative to the fixing seat 1 since the hook 33 abuts against the first anti-rotation portion 13. To improve smoothness of the motion above, the second anti-rotation portion 3b of this specific embodiment preferably has two opposite plates 32 and two hooks 33 facing each other, so as to correspond to the symmetrical first anti-rotation portion 13 to further provide better guided displacement and anti-rotation effects.

On the other hand, the fixing member reciprocation generating member 3 can have a retraction and obtrusion unit 31, or the connection unit 22 can be inserted at the retraction and obtrusion unit 31 and the through hole 11 of the fixing seat 1, or when the fixing member reciprocation generating member 3 displaces relative to the fixing seat 1, the retraction and obtrusion unit 31 can drive the fixing member 2 to reciprocate so as to compress or release the elastic element 4. The this specific embodiment, the fixing member reciprocation generating member 3 can have a retraction and obtrusion unit 31 disposed at the base plate 3a, and the retraction and obtrusion unit 31 can be partially aligned with the through hole 11 when the fixing member reciprocation generating member 3 is assembled at the fixing seat 1. Thus, the connection unit 22 of the fixing member 2 can pass through the retraction and obtrusion unit 31 and the through hole 11, and when the fixing member reciprocation generating member 3 displaces relative to the fixing seat 1, the retraction and obtrusion unit 31 can drive the fixing member 2 to reciprocate so as to compress or release the elastic element 4.

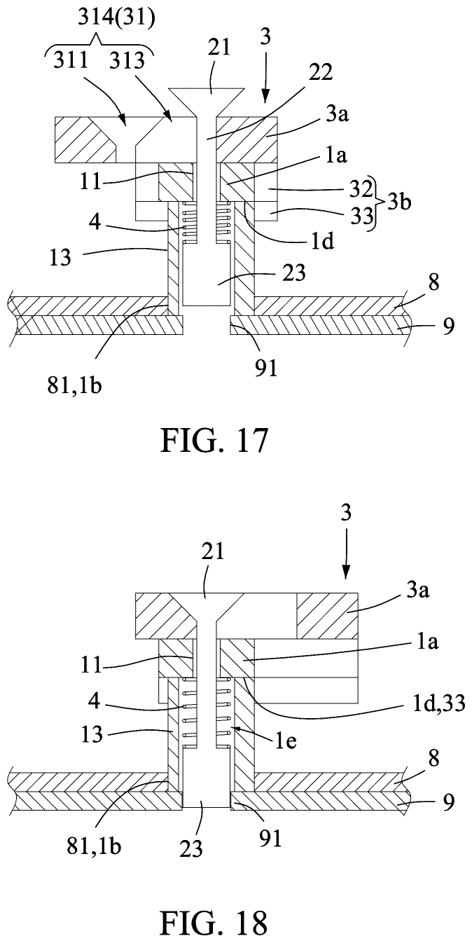

For example, the retraction and obtrusion unit 31 of this specific embodiment can have a groove 314. The groove 314 can penetrate the base plate 3a, and can have a retraction region 311 and an obtrusion region 313 connected to each other. A groove width of the groove 314 in the obtrusion region 313 can be greater than a width of the connection unit 22 and less than a width of the stop unit 21, so that the stop unit 21 protrudes out of the groove 314 when aligned with the obtrusion region 313 (as shown in FIG. 17). The groove 314 can be further provided with an outward tilted stop surface 312 in the retraction region 311 so as to form an accommodating chamber as an inverted cone, so that the stop unit 21 is at least partially immersed in the groove 314 when aligned with the retraction region 311 (as shown in FIG. 18).

It should be noted that, to provide ease of assembly, at least one of the stop unit 21 and the fixing unit 23 of the fixing member 2 is preferably coupled to the connection unit 22 only after the connection unit 22 passes through the through hole 11 and the groove 314, or the connection unit 22 is processed so as to form the stop unit 21 or the fixing unit 23. Associated details of the above can be understood by a person of ordinary skill in the art and are not a focus of the present disclosure, and are thus depicted in an integrally connected form in the drawings.

As shown in FIG. 17, according to the structure above, when the retaining assembly according to the second implementation form of the present disclosure put to use, the fixing seat 1 can be first coupled with the fixing through hole 81 of the first object 8 by the assembly portion 1b thereof, and the fixing member reciprocation generating member 3 is then aligned with the fixing member 2 by the obtrusion region 313 of the retraction and obtrusion unit 31. At this point, the base plate 3a of the fixing member reciprocation generating member 3 pushes the stop unit 21 of the fixing member 2 upward, and the elastic element 4 is pressurized by the fixing unit 23 moved upward, for the fixing member 2 to be securely abutting against the base plate 3a of the fixing member reciprocation generating member 3 without swaying easily, further for the fixing unit 23 to be easily and accurately aligned above the fixing hole 91 of the second object 9.

Then, as shown in FIG. 18, the fixing member reciprocation generating member 3 is operated to displace laterally so that the retraction and obtrusion unit 31 switches to be aligned with the fixing member 2 instead of with the retraction region 311. At this point, the stop unit 21 of the fixing member 2 can be aligned with the outward tilted stop surface 312 and be immersed in the groove 314, and thus the elastic element 4 can release a pre-force to drive the entire fixing member 2 to displace downward, for the fixing unit 23 to be inserted into the fixing hole 91 of the second object 9, thereby achieving an effect of fixing the first object 8 and the second object 9.

Again referring to FIG. 15, in one specific embodiment, the assembly portion 1b of the fixing seat 1 and the fixing through hole 81 of the first object 8 can be formed to have a non-circular matching form, or are for restricting a direction of the fixing seat 1 at the first object 8 to further restrict or conform to restricting directions of the first anti-rotation portion 13 and the second anti-rotation portion 3b, for the assembly portion 1b of the fixing seat 1 and the fixing through hole 81 of the first object 8 to also generate an anti-rotation effect when coupled, and this helps enhancing coupling stability of the fixing seat a and the first object 8 as well as improving stability of the fixing member reciprocation generating member 3 when it is pushed in subsequent operations. Moreover, to improve the ease of operation of the fixing member reciprocation generating member 3, the base plate 3a of the fixing member reciprocation generating member 3 can be further provided with a lift portion 34 protruding outward at one edge in a push direction thereof, so as to facilitate a user to hold by a finger and to apply a force.

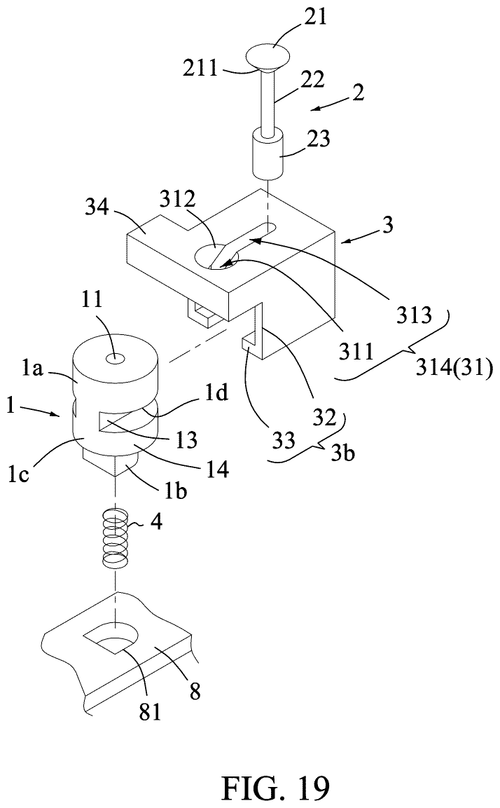

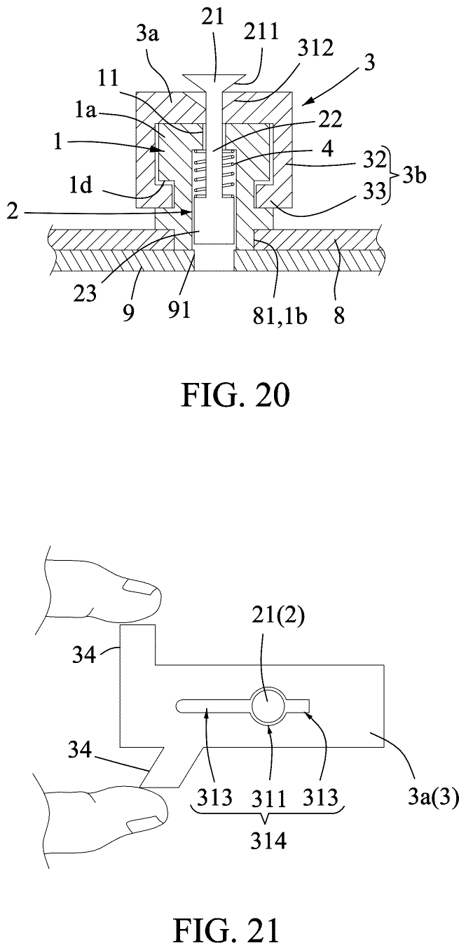

Referring to FIG. 19 and FIG. 20, in another specific embodiment according to the second implementation form of the present disclosure, an auxiliary limiting portion 14 can be further provided between the first anti-rotation portion 13 and the assembly portion 1b of the fixing seat 1, for the hook 33 of the fixing member reciprocation generating member 3 to extend to be between the shoulder 1d and the auxiliary limiting portion 14, hence further more stably reciprocating along the first anti-rotation portion 13.

Referring to FIG. 21, in yet another specific embodiment according to the second implementation form of the present disclosure, the groove 314 of the retraction and obtrusion unit 31 of the fixing member reciprocation generating member 3 can further have a retraction region 311 between two obtrusion regions 313. Thus, when a user pushes the fixing member reciprocation generating member 3 toward either the left or the right, the operations of the first object 8 and the second object 9 described above can be implemented, hence achieving an effect of improved convenience of operation. In addition, the base plate 3a of the fixing member reciprocation generating member 3 can be further provided with a lift portion 34 protruding outward on each of both sides of one edge in the push direction thereof, for a user to hold by two fingers, hence further achieving effects of improved ease and smoothness of operation.

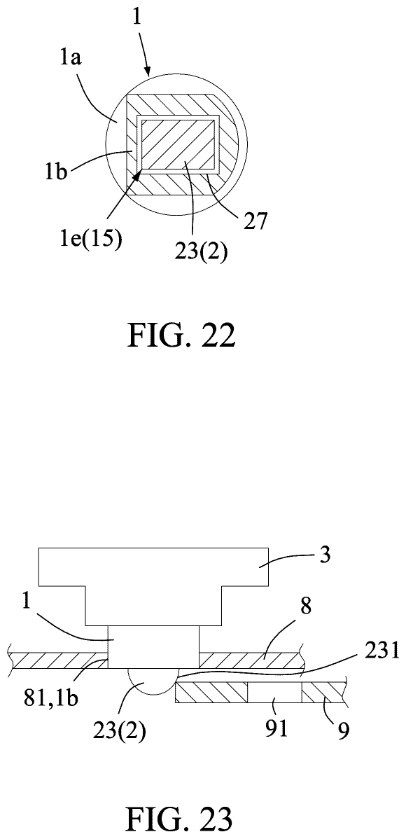

Referring to FIG. 22, in yet another specific embodiment according to the second implementation form of the present disclosure, the fixing member 2 can be prevented from rotating relative to the fixing seat 1. That is, the fixing seat 1 can have a third anti-rotation portion 15 and the fixing unit 23 can have a fourth anti-rotation portion 27 corresponding to the third anti-rotation portion 15, hence achieving an effect of restricting and preventing rotation of the fixing member 2. For example, in the fixing seat 1 of this specific embodiment, a radial cross section of the accommodating chamber le of the assembly portion 1b can be formed as a non-circular pattern so as to form the third anti-rotation portion 15. Moreover, in the fixing unit 23, a radial cross section of the fourth anti-rotation portion 27 is formed to have a pattern matching the accommodating chamber 1e. Thus, when the fixing unit 23 is located with the accommodating chamber 1e of the assembly portion 1b, the fourth anti-rotation portion 27 and the third anti-rotation portion 15 can be restricted by each other and are prevented from rotating relative to each other, thereby achieving an effect of preventing the fixing member 2 to rotate relative to the fixing seat 1.

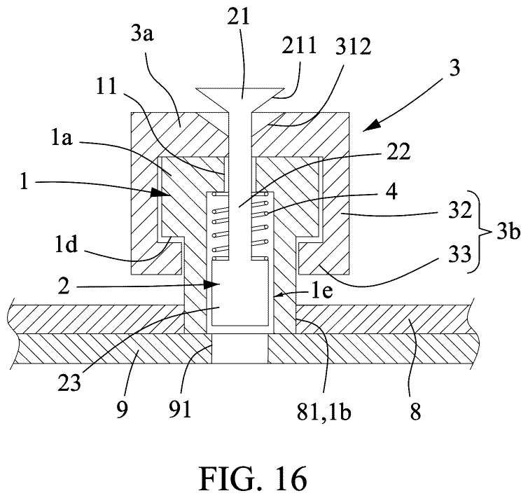

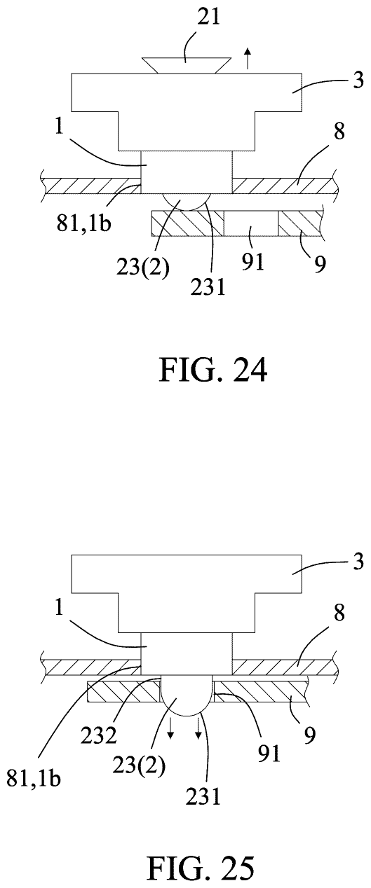

On the other hand, referring to FIG. 23, in this specific embodiment, the fixing unit 23 of the fixing member 2 can further have a guide surface 231. The guide surface 231 can be located at a bottom end of the fixing unit 23, for example, having the bottom end of the fixing unit 23 formed as a convex semi-sphere, or the guide surface 231 can also be formed as an arched surface, a round surface, a curved surface, a stepped surface of a sloped surface. Accordingly, referring to FIG. 23 to FIG. 25, after the fixing seat 1 is coupled with the fixing through hole 81 of the first object 8 by the assembly portion 1b thereof, when the bottom end of the fixing unit 23 of the fixing member 2 protrudes from the assembly portion 1b and can come into contact with an edge of the second object 9 (as shown in FIG. 9), with guidance of the guide surface 231, the second object 9 abuts against the guide surface 231, for the fixing member 2 to displace upward and pressurize the elastic element 4 (denoted in FIG. 16), and that the bottom end of the fixing unit 23 can abut against the second object 9 and move levelly relative to the second object 9 (as shown in FIG. 24). When the bottom end of the fixing unit 23 is aligned with the fixing hole 91 of the second object 9, the elastic element 4 can release the pressure to drive the entire fixing member 2 to displace downward, for the fixing unit 23 to be inserted into the fixing hole 91 of the second object 9, thereby achieving an effect of coupling and fixing the first object 8 and the second object 9 (as shown in FIG. 25).

Moreover, the fixing unit 23 can have a limiting portion 232 for restricting the second object 9, or one side of the fixing unit 23 can have the guide surface 231 and one other side can have a limiting portion 232 for guiding the fixing unit 23 by the guide surface 231 to enter the second object 9 or being restricted by the limiting portion 232 from separating. In one of the specific embodiments according to the second implementation form of the present disclosure, the guide surface 231 can be formed adjacent to the bottom end of the fixing unit 23 of the fixing member 2, and the limiting portion 232 is formed at a straighter portion of a periphery of the fixing unit 23. Accordingly, the bottom end of the fixing unit 23 of the fixing member 2 can be guided by the guide surface 231, for the levelly displaced fixing member 2 to be pushed by the edge of the second object 9 and thus retract upward. Moreover, when the bottom end of the fixing unit 23 is aligned with and inserted into the fixing hole 91 of the second object 9, the limiting portion 233 restricts the fixing member 2 from moving backward so that the fixing member 2 is retracted, hence further achieving an effect of improved coupling stability of the first object 8 and the second object 9. Moreover, with the fixing member 2 and the fixing seat 1 restricted and prevented from rotation, or the fixing member 2 and the fixing member reciprocation generating member 3 restricted and prevented from rotation, a direction of the guide surface 231 or a direction of the limiting portion 232 is restricted.

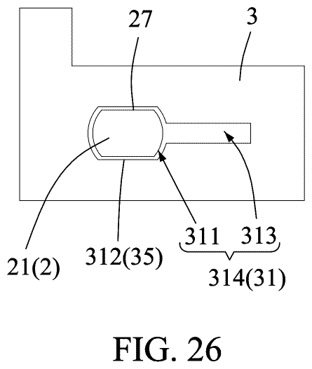

Referring to FIG. 26, in yet another specific embodiment according to the second implementation form of the present disclosure, the fixing member 2 can be prevented from rotating relative to the fixing member reciprocation generating member 3. That is, the fixing member reciprocation generating member 3 can have a fifth anti-rotation portion 35 and the fourth anti-rotation portion 27 of the fixing member 2 can correspond to the fifth anti-rotation portion 35, hence achieving an effect of restricting and preventing rotation of the fixing member 2. For example, in the fixing member reciprocation generating member 3, the outward tilted stop surface 312 of the retraction region 311 of the groove 314 can be formed as an accommodating chamber of an inverted cone in a non-circular pattern to form the fifth anti-rotation portion 35, and the stop unit 21 of the fixing member 2 is formed to have a pattern matching the outward tilted stop surface 312 of the retraction region 311 so as to form the fourth anti-rotation portion 27. Thus, when the stop unit 21 is aligned within the retraction region 311, the fourth anti-rotation portion 27 and the fifth anti-rotation portion 35 can restrict each other and are prevented from rotating relative to each other, thereby achieving an effect of preventing the fixing member 2 to rotate relative to the fixing member reciprocation generating member 3.

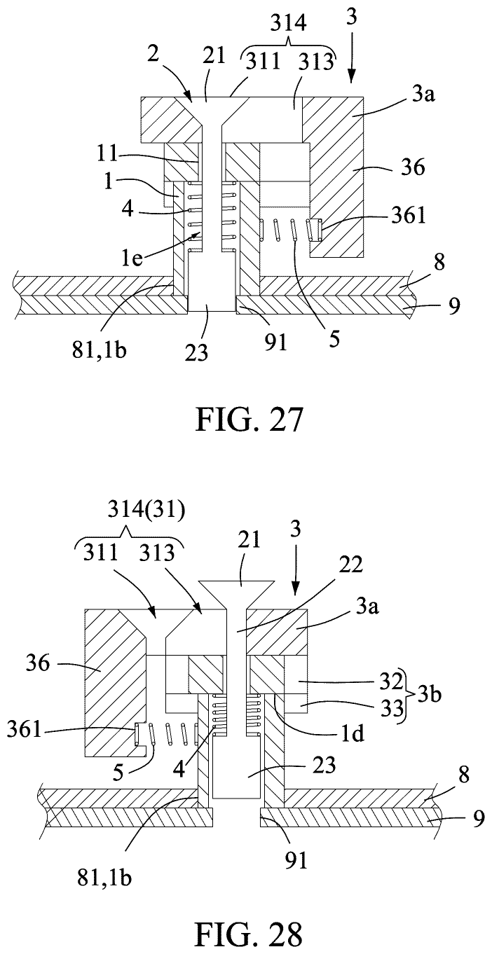

Referring to FIG. 27, in one of the specific embodiments according to the second implementation form of the present disclosure, an elastic reset member 5 provided laterally can be included. One end of the elastic reset member 5 abuts against the fixing member reciprocation generating member 3 and the other end abuts against the fixing seat 1, for the fixing member 2 to be located at a descending position or at an ascending position. More specifically, the base plate 3a of the fixing member reciprocation generating member 3 can be provided with an extension portion 36 extending downward on one of the ends in a push direction, one end of the elastic reset member 5 abuts against the extension portion 36, or the extension portion 36 can be provided with a recess 361, an opening of the recess 361 faces the fixing seat 1, and the recess 361 can accommodate one end of the elastic reset member 5 so as to enhance stability of the elastic reset member 5. In this specific embodiment, the extension portion 36 of the fixing member reciprocation generating member 3 is disposed at a position closer to the obtrusion region 313 and farther away from the retraction region 311. Accordingly, when the retaining assembly is in a state of not subject to any force, the extension portion 36 of the fixing member reciprocation generating member 3 can receive an elastic action of the elastic reset member 5 to be kept at a predetermined distance from the fixing seat 1. At this point, the stop unit 21 of the fixing member 2 can be aligned with the retraction region 311 and be immersed in the groove 314, and the fixing unit 23 of the fixing member 2 can be in an extended state.

When locking at the second object 9 is desired, a user can operate and push the fixing member reciprocation generating member 3 to move the extension portion 36 in a direction close to the fixing seat, 1 so as to compress the elastic reset member 5 and to guide and lift the stop unit 21 of the fixing member 2 from the obtrusion region 313 of the groove 314, for the fixing unit 23 of the fixing member 2 to retract upward and compress the elastic element 4. After the fixing unit 23 is aligned above the fixing hole 91 of the second object 9, the user can release the fixing member reciprocation generating member 3, the extension portion 36 of the fixing member reciprocation generating member 3 can move in a direction away from the fixing seat 1 by elastic reset of the elastic reset member 5, so that the stop unit 21 of the fixing member 2 is aligned with the retraction region 311 and is immersed in the groove 314, for the fixing unit 23 of the fixing member 2 to extend out and be inserted into the fixing hole 91 of the second object 9, hence achieving an effect of improved convenience of operation for locking.

Referring to FIG. 28, in another specific embodiment, the extension portion 36 of the fixing member reciprocation generating member 3 is disposed at a position closer to the retraction region 311 and farther away from the obtrusion region 313. Accordingly, when the retaining assembly is in a state of not subject to any force, the extension portion 36 of the fixing member reciprocation generating member 3 can receive an elastic action of the elastic reset member 5 to be kept at a predetermined distance from the fixing seat 1. At this point, the stop unit 21 of the fixing member 2 can be aligned with the obtrusion region 313, and the fixing member 2 can be in a lifted state and compress the elastic element 4.

When locking at the second object 9 is desired, a user can operate the fixing member reciprocation generating member 3 to move the extension portion 36 in a direction close to the fixing seat 1, so as to compress the elastic reset member 5, the stop unit 21 of the fixing member 2 can be aligned with the retraction region 311 and be immersed in the groove 314, and the elastic element 4 can then be elastically reset to push the fixing unit 23 of the fixing member 2 to extend out and be inserted into the fixing hole 91 of the second object 9. To release the lock state, a user is only required to lightly push the fixing member reciprocation generating member 3 to move the extension portion 36 in a direction away from the fixing seat 1, and the entire fixing member reciprocation generating member 3 can be driven to displace by the elastic reset ability of the elastic reset member 5, so that the extension portion 36 moves in a direction away from the fixing seat 1, and the stop unit 21 of the fixing member 2 is aligned with the obtrusion 313 of the groove 314, for the fixing member 2 to be lifted and be readily separated from the second object 9, hence achieving an effect of improved convenience of operation during unlocking.

The first object 8 or the second object 9 can be a server, a memory, a motherboard, a printed circuit board (PCB), a rail, a cabinet, a data center, an integrated circuit (IC), a chip, a heat sink, a fan, a casing, a housing, a metal object or a plastic object.

In conclusion, in the retaining assembly according to the first implementation form of the present disclosure, with the fixing member reciprocation generating member 3 and the elastic member 4, the fixing unit 23 is caused to reciprocate and the fixing member 2 is kept from swaying easily. Moreover, in the retaining assembly according to the first implementation form of the present disclosure, with the fixing member reciprocation generating member 3, the fixing unit 23 can easily reciprocate outside and inside the fixing seat 1 (as shown in FIG. 2 and FIG. 4), or reciprocate outside the fixing seat 1 (as shown in FIG. 3 and FIG. 4). Moreover, with the first anti-rotation portion 13 and the second anti-rotation portion 3b matching each other provided, the retaining assembly of the second implementation form of the present disclosure can further limit the fixing member reciprocation generating member 3 to be only able to displace relative to the fixing seat 1 without any relative rotation (the rotation herein refers to relative rotation at a large amplitude, but does not eliminate slight rotation generated by structural adaptation or clearance fit), thereby achieving effects of further improved stability, convenience and efficiency of operation during an assembly process.

The present invention is described by way of the preferred embodiments above. A person skilled in the art should understand that, these embodiments are merely for describing the present invention are not to be construed as limitations to the scope of the present invention. It should be noted that all equivalent changes, replacements and substitutions made to the embodiments are to be encompassed within the scope of the present invention. Therefore, the scope of protection of the present invention should be accorded with the broadest interpretation of the appended claims.

What is claimed is:

1. A retaining assembly, comprising:
a fixing seat, having a first anti-rotation portion;
a fixing member, inserted at the fixing seat and having a stop unit, a connection unit and a fixing unit that are sequentially connected; and
a fixing member reciprocation generating member, having a second anti-rotation portion aligned with the first anti-rotation portion, for restricting and preventing rotation of the fixing member reciprocation generating member, the fixing member reciprocation generating member displacing relative to the fixing seat to drive the fixing member to reciprocate; or, an elastic element, wherein the elastic element is located at the fixing seat or two ends of the elastic element respectively abut against the fixing seat and the fixing unit.

2. The retaining assembly according to claim 1, wherein the second anti-rotation portion has an extended structure or a hook connected to the structure, or a head of the fixing seat is accommodated between the hook and a base plate, or the hook is aligned with the first anti-rotation portion and extends into a shoulder of the fixing seat.

3. The retaining assembly according to claim 1, wherein the first anti-rotation portion and an assembly portion of the fixing seat have an auxiliary limiting portion in between, or the second anti-rotation portion can extend to be between the first anti-rotation portion and the auxiliary limiting portion; or, an assembly portion of the fixing seat and a fixing through hole of a first object form a matching anti-rotation structure, or are for limiting a direction of the fixing seat at the first object for restricting or conforming to limit directions of the first anti-rotation portion and the second anti-rotation portion.

4. The retaining assembly according to claim 1, wherein the first anti-rotation portion forms a plane on each of two radially opposite positions so that the first anti-rotation portion is formed to be symmetrical.

5. The retaining assembly according to claim 4, wherein the second anti-rotation portion has two plates extending downward from a base plate, or each of the plates is connected to a hook and the two hooks face each other, or a head of the fixing seat is accommodated between the two hooks and the base plate, or the two hooks are aligned with the two planes and extend into a shoulder of the fixing seat.

6. A retaining assembly, comprising:
a fixing seat, having a third anti-rotation portion;
a fixing member, inserted at the fixing seat and having a stop unit, a connection unit and a fixing unit that are sequentially connected, the fixing member having a fourth anti-rotation portion corresponding to the third anti-rotation portion and restricting and preventing rotation of the fixing member; and
a fixing member reciprocation generating member, displacing relative to the fixing seat to drive the fixing member to reciprocate; or, an elastic element, wherein the elastic element is located at the fixing seat or two ends of the elastic element respectively abut against the fixing seat and the fixing unit.

7. The retaining assembly according to claim 6, wherein a radial cross section of an accommodating chamber in the fixing seat is formed to have a non-circular pattern so as to form the third anti-rotation portion, or a radial cross section of the fixing unit at the fourth anti-rotation portion is formed to have a pattern matching the accommodating chamber.

8. A retaining assembly, comprising:
a fixing seat;
a fixing member, inserted at the fixing seat and having a stop unit, a connection unit and a fixing unit that are sequentially connected, the fixing member having a fourth anti-rotation portion; and
a fixing member reciprocation generating member, having a fifth anti-rotation portion corresponding to the fourth anti-rotation portion and restricting and preventing rotation of the fixing member, the fixing member reciprocation generating member displacing relative to the fixing seat to drive the fixing member to reciprocate; or, an elastic element, wherein the elastic element is located at the fixing seat or two ends of the elastic element respectively abut against the fixing seat and the fixing unit.

9. The retaining assembly according to claim 8, wherein an outward tilted stop surface of a retraction region of the fixing member reciprocation generating member is formed as an inverted cone having a non-circular pattern so as to form the fifth anti-rotation portion, or a stop unit of the fixing member is formed to have a pattern matching the outward tilted stop surface so as to form the fourth anti-rotation portion; or, the fixing member reciprocation generating member has a retraction and obtrusion unit, or the connection unit is inserted at the retraction and obtrusion unit and a through hole of the fixing seat, or when the fixing member reciprocation generating member displaces relative to the fixing seat, the retraction and obtrusion unit drives the fixing member to reciprocate so as to compress or release an elastic element; or, the fixing member reciprocation generating member has a retraction and obtrusion unit, or the retraction and obtrusion unit has a groove, or the groove has a retraction region and at least one obtrusion region connected to each other, or the stop unit protrudes out of the groove when aligned with the obtrusion region, or the stop unit is at least partially immersed in the groove when aligned with the retraction region, or the obtrusion region of the groove is two in quantity, or the retraction region is located between the two obtrusion regions, or the stop unit is formed as an inverted cone tapered gradually toward the connection unit and has an inward tilted stop surface, or the groove is provided with an outward tilted stop surface in the retraction region so as to correspond to the inward tilted stop surface.

10. A retaining assembly, comprising:
a fixing seat;
a fixing member, inserted at the fixing seat and having a stop unit, a connection unit and a fixing unit that are sequentially connected;
a fixing member reciprocation generating member, displacing relative to the fixing seat to drive the fixing member to reciprocate; and
an elastic reset member, having one end abutting against the fixing member reciprocation generating member and one other end abutting against the fixing seat for the fixing member to be located at a descending position or at an ascending position; or, an elastic element, wherein the elastic element is located at the fixing seat or two ends of the elastic element respectively abut against the fixing seat and the fixing unit.

11. The retaining assembly according to claim 10, wherein the fixing member reciprocation generating member has an extension portion, and one end of the elastic reset member abuts against the extension portion, or the extension portion is provided with a recess for accommodating the one end of the elastic reset member; or, the fixing member reciprocation generating member has a retraction region and an obtrusion region, or the stop unit protrudes when aligned with the obtrusion region, or the stop unit is at least partially immersed when aligned with the retraction region, or the fixing member reciprocation generating member has an extension portion, or the extension portion is closer to the obtrusion region and farther away from the retraction region, or the extension portion is closer to the retraction region and farther away from the obtrusion region, or the one end of the elastic reset member abuts against the extension portion; or, the fixing member reciprocation generating member has a retraction and obtrusion unit, or the connection unit is inserted at the retraction and obtrusion unit and a through hole of the fixing seat, or when the fixing member reciprocation generating member displaces relative to the fixing seat, or the retraction and obtrusion unit drives the fixing member to reciprocate so as to compress or release an elastic element; or, the fixing member reciprocation generating member has a retraction and obtrusion unit, or the retraction and obtrusion unit has a groove, or the groove has a retraction region and at least one obtrusion region connected to each other, or the stop unit protrudes out of the groove when aligned with the obtrusion region, or the stop unit is at least partially immersed in the groove when aligned with the retraction region, or the obtrusion region of the groove is two in quantity, or the retraction region is located between the two obtrusion regions, or the stop unit is formed as an inverted cone tapered gradually toward the connection unit and has an inward tilted stop surface, or the groove is provided with an outward tilted stop surface in the retraction region so as to correspond to the inward tilted stop surface.

12. A retaining assembly, comprising:
a fixing seat;
a fixing member, inserted at the fixing seat and having a stop unit, a connection unit and a fixing unit that are sequentially connected, the fixing unit having a guide surface for guiding the fixing unit to move or operate; and
a fixing member reciprocation generating member, displacing relative to the fixing seat to drive the fixing member to reciprocate; or, an elastic element, wherein the elastic element is located at the fixing seat or two ends of the elastic element respectively abut against the fixing seat and the fixing unit.

13. The retaining assembly according to claim 12, wherein the fixing unit has a limiting portion for restricting a second object, or one side of the fixing unit has the guide surface and one other side has a limiting portion for guiding the fixing unit by the guide surface to enter the second object or being restricted by the limiting portion from separating.

14. The retaining assembly according to claim 12, wherein the fixing member and the fixing seat are restricted and prevented from rotation, or the fixing member and the fixing member reciprocation generating member are restricted and prevented from rotation, so as to restrict a direction of the guide surface or a direction of a limiting portion of the fixing unit.

15. The retaining assembly according to claim 1, wherein the fixing member reciprocation generating member has a retraction and obtrusion unit, or the connection unit is inserted at the retraction and obtrusion unit and a through hole of the fixing seat, or when the fixing member reciprocation generating member displaces relative to the fixing seat, the retraction and obtrusion unit drives the fixing member to reciprocate so as to compress or release an elastic element; or, the fixing member reciprocation generating member has a retraction and obtrusion unit, or the retraction and obtrusion unit has a groove, or the groove has a retraction region and at least one obtrusion region connected to each other, or the stop unit protrudes out of the groove when aligned with the obtrusion region, or the stop unit is at least partially immersed in the groove when aligned with the retraction region, or the obtrusion region of the groove is two in quantity, or the retraction region is located between the two obtrusion regions, or the stop unit is formed as an inverted cone tapered gradually toward the connection unit and has an inward tilted stop surface, or the groove is provided with an outward tilted stop surface in the retraction region so as to correspond to the inward tilted stop surface.

16. The retaining assembly according to claim 6, wherein the fixing member reciprocation generating member has a retraction and obtrusion unit, or the connection unit is inserted at the retraction and obtrusion unit and a through hole of the fixing seat, or when the fixing member reciprocation generating member displaces relative to the fixing seat, the retraction and obtrusion unit drives the fixing member to reciprocate so as to compress or release an elastic element; or, the fixing member reciprocation generating member has a retraction and obtrusion unit, or the retraction and obtrusion unit has a groove, or the groove has a retraction region and at least one obtrusion region connected to each other, or the stop unit protrudes out of the groove when aligned with the obtrusion region, or the stop unit is at least partially immersed in the groove when aligned with the retraction region, or the obtrusion region of the groove is two in quantity, or the retraction region is located between the two obtrusion regions, or the stop unit is formed as an inverted cone tapered gradually toward the connection unit and has an inward tilted stop surface, or the groove is provided with an outward tilted stop surface in the retraction region so as to correspond to the inward tilted stop surface.

17. The retaining assembly according to claim 12, wherein the fixing member reciprocation generating member has a retraction and obtrusion unit, or the connection unit is inserted at the retraction and obtrusion unit and a through hole of the fixing seat, or when the fixing member reciprocation generating member displaces relative to the fixing seat, the retraction and obtrusion unit drives the fixing member to reciprocate so as to compress or release an elastic element; or, the fixing member reciprocation generating member has a retraction and obtrusion unit, or the retraction and obtrusion unit has a groove, or the groove has a retraction region and at least one obtrusion region connected to each other, or the stop unit protrudes out of the groove when aligned with the obtrusion region, or the stop unit is at least partially immersed in the groove when aligned with the retraction region, or the obtrusion region of the groove is two in quantity, or the retraction region is located between the two obtrusion regions, or the stop unit is formed as an inverted cone tapered gradually toward the connection unit and has an inward tilted stop surface, or the groove is provided with an outward tilted stop surface in the retraction region so as to correspond to the inward tilted stop surface.
